(19) United States
(12) Patent Application Publication
(10) Pub. No.: US 2015/0327100 A1
(43) Pub. Date: Nov. 12, 2015

(54) IDLE INTERVAL AND DEDICATED CHANNEL MEASUREMENT OCCASION CONFIGURATIONS

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/275,638

(22) Filed: May 12, 2014

(51) Int. Cl. H04W 24/10; H04W 72/04

(52) U.S. Cl. CPC H04W 24/10; H04W 72/04

(57) ABSTRACT

An apparatus and method for wireless communication extends a measurement gap in a high speed data network. When it is determined a high speed data channel will fall within a measurement gap, the monitoring of the grant channel corresponding to the high speed data channel is skipped. The measurement gap is extended for inter radio access technology (IRAT) measurement to include the time slot containing the grant channel when the time slot only includes the grant channel corresponding to the high speed data channel that will fall in the measurement gap.

### BACKGROUND

1. Field

Aspects of the present disclosure relate generally to wireless communication systems, and more particularly, to extending a measurement gap in a high speed data network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of wireless communication is disclosed. The method includes determining whether a high speed data channel will fall within a measurement gap. When the high speed data channel will fall within the measurement gap, the monitoring of a grant channel corresponding to the high speed data channel is skipped. The measurement gap for inter radio access technology (IRAT) measurement is extended to include a time slot containing the grant channel when the time slot only includes the grant channel corresponding to the high speed data channel that will fall in the measurement gap.

Another aspect discloses wireless communication having a memory and at least one processor coupled to the memory. The processor(s) is configured to determine whether a high speed data channel will fall within a measurement gap. The processor(s) is configured to skip the monitoring of a grant channel corresponding to the high speed data channel when the high speed data channel will fall within the measurement gap. The processor(s) is also configured to extend the measurement gap for inter radio access technology (IRAT) measurement to include a time slot containing the grant channel when the time slot only includes the grant channel corresponding to the high speed data channel that will fall in the measurement gap.

In another aspect, a computer program product for wireless communications in a wireless network having a non-transitory computer-readable medium is disclosed. The computer readable medium has non-transitory program code recorded thereon which, when executed by the processor(s), causes the processor(s) to perform operations of determining whether a high speed data channel will fall within a measurement gap. The program code also causes the processor(s) to skip monitoring of a grant channel corresponding to the high speed data channel, when the high speed data channel will fall within the measurement gap. The program code also causes the processor(s) to extend the measurement gap for inter radio access technology (IRAT) measurement to include a time slot containing the grant channel when the time slot only includes the grant channel corresponding to the high speed data channel that will fall in the measurement gap.

Another aspect discloses an apparatus including means for determining whether a high speed data channel will fall within a measurement gap. Also included is a means for skipping monitoring of a grant channel corresponding to the high speed data channel, when the high speed data channel will fall within the measurement gap. The apparatus also includes a means for extending the measurement gap for inter radio access technology (IRAT) measurement to include a time slot containing the grant channel when the time slot only includes the grant channel corresponding to the high speed data channel that will fall in the measurement gap.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a block diagram illustrating an example of subframe structures in a telecommunications system.

FIG. 6 is a method for extending a measurement gap according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

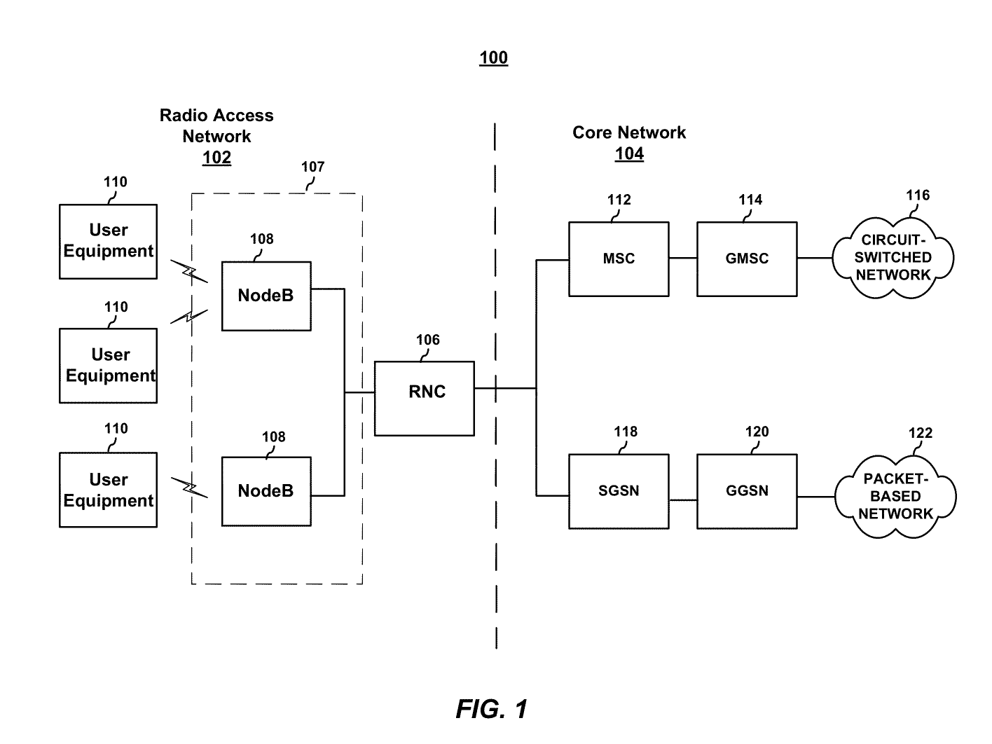

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

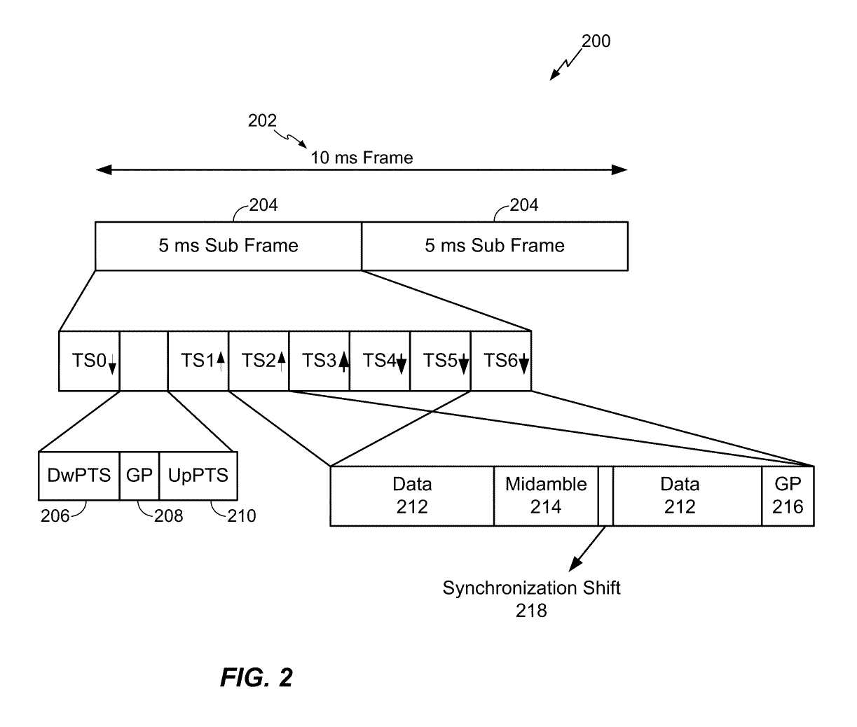

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

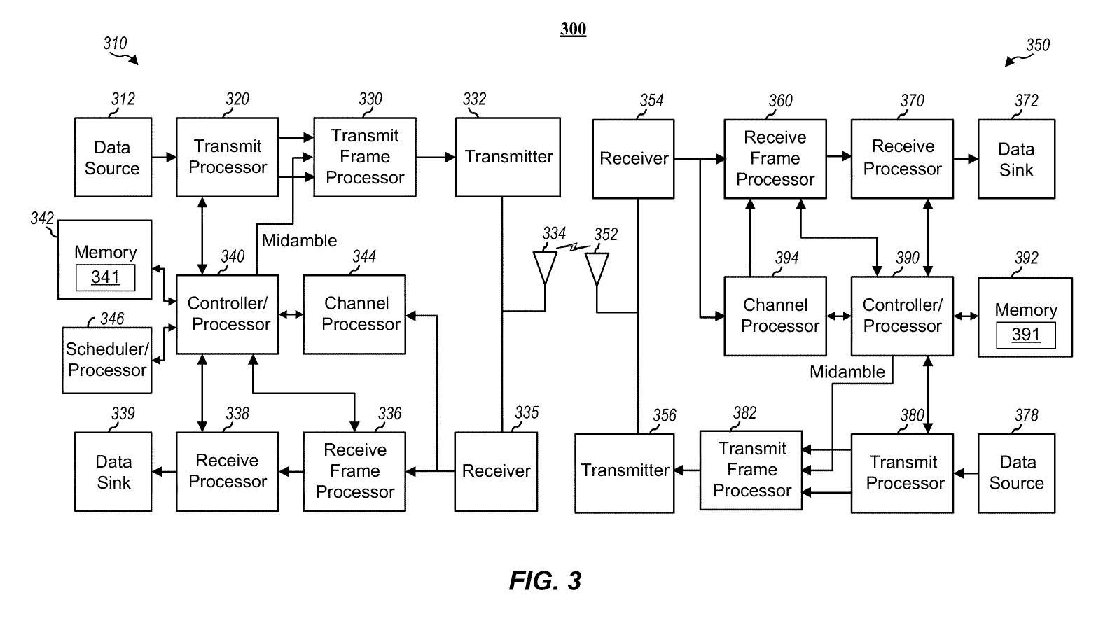

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The computer readable media of memories 392 may store data and software for the UE 350. For example, the memory 392 of the UE 350 may store a gap management module 391 which, when executed by the controller/processor 390, configures the UE 350 for extending a measurement gap.

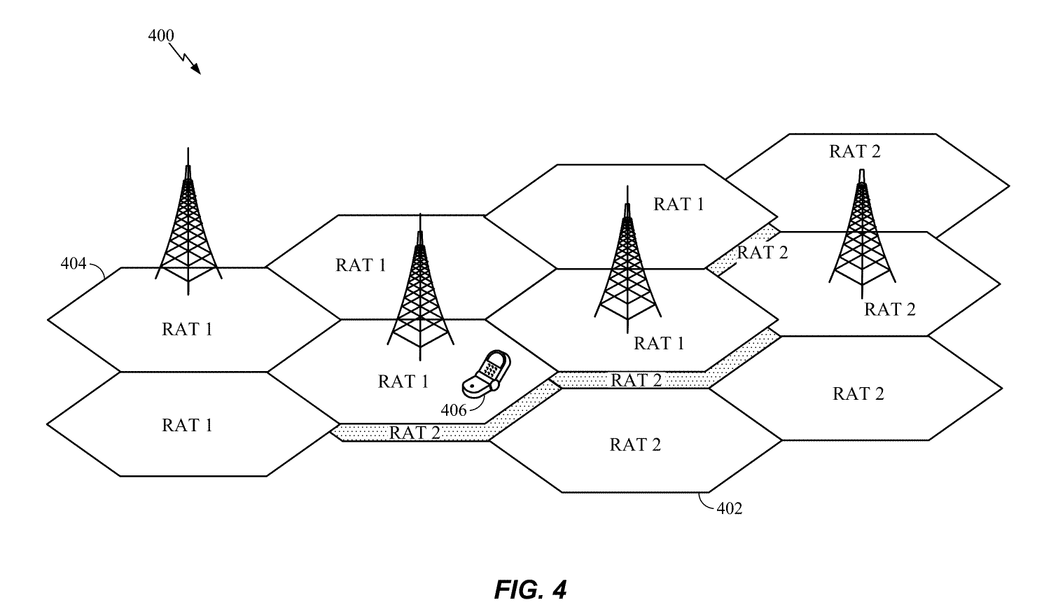

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (i.e., RAT-1), such as a TD-SCDMA network, and also illustrates a newly deployed network utilizing a second type of radio access technology (i.e., RAT-2), such as an LTE network. The geographical area 400 includes RAT-1 cells 402 and RAT-2 cells 404. In one example, the RAT-1 cells are TD-SCDMA cells and the RAT-2 cells are LTE cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

The handover or cell reselection may be performed when the UE moves from the coverage area of a first radio access technology (RAT) (e.g., a TD-SCDMA cell) to the coverage area of a second RAT (e.g., a LTE cell), or vice versa. A handover or cell reselection may also be performed when there is a coverage hole or lack of coverage in, for example, the LTE network or when there is traffic balancing between the TD-SCDMA and LTE networks. Additionally, handover from a first RAT to a second RAT may also occur when the network prefers to have the user equipment (UE) use the first RAT as a primary RAT but use the second RAT simply for voice service(s).

As part of that handover or cell reselection process, while in a connected mode with a first system (e.g., TD-SCDMA) the UE may be specified to perform a measurement of a neighboring cell (such as an LTE cell). For example, the UE may measure the neighbor cells of a second network for signal strength. The UE may then connect to the strongest cell of the second network. Such measurement may be referred to as inter radio access technology (IRAT) measurement.

In one example, when the UE is in a TD-SCDMA connected mode, the UE receives instructions from the network on where to perform LTE measurement(s). In particular, the network may instruct the UE to use an idle interval or a dedicated channel (DCH) measurement occasion (DMO) for LTE measurement(s). For example, according to some Third Generation Partnership Project (3GPP) specifications, the network configures the idle interval for LTE measurements in the TD-SCDMA connected mode. The configuration occurs after the UE identifies the idle interval specified by the network for connected mode measurements from TD-SCDMA to LTE in a measurement capability TDD. In one example, the idle interval may be a single 10 millisecond (ms) TD-SCDMA radio frame within a 40 or 80 ms period, such as a transmit time interval (TTI).

The TD-SCDMA network can also configure a CELL_DCH measurement occasion for IRAT measurement. In the CELL_DCH state, when the CELL_DCH measurement occasion pattern sequence is configured and activated for the specified measurement purpose, the UE performs corresponding measurements as specified in information element (IE) “Timeslot Bitmap.” In particular the measurements are performed within the frames: “system frame number (SFN) start” frame to the “SFNstart+M_Length−1” frame, where the SFNstart fulfills the following equation:

SFNstart mod(2k)=offset

And where, k is a CELL_DCH measurement occasion cycle length coefficient signaled by an information element (IE) variable “k” in an IE “CELL_DCH measurement occasion info LCR (low chip rate).” The actual measurement occasion period is equal to 2k radio frames. The offset is a measurement occasion position in the measurement period. The offset is signaled by an information element (IE) “offset” in the IE “CELL_DCH measurement occasion info LCR.” Further, M_Length is the actual measurement occasion length in frames starting from the offset and is signaled by the IE M_Length in the IE “CELL_DCH measurement occasion info LCR.” For example, M_Length can be 10, 20 or 30 ms. M_Length is also referred to as a network defined gap length.

### High Speed Networks

High speed networks are utilized to improve the uplink and downlink throughput. In particular, the high speed downlink packet access (HSDPA) or time division high speed downlink packet access (TD-HSDPA) is a set of enhancements to time division synchronous code division multiple access (TD-SCDMA) in order to improve downlink throughput. Additionally, the high speed uplink packet access (HSUPA) or time division high speed uplink packet access (TD-HSUPA) is a set of enhancements to time division synchronous code division multiple access (TD-SCDMA) in order to improve uplink throughput.

In TD-HSDPA, the following physical channels are relevant. The high-speed physical downlink shared channel (HS-PDSCH) carries a user data burst(s). The high-speed shared control channel (HS-SCCH), also referred to as the grant channel, carries the modulation and coding scheme, channelization code, time slot and transport block size information for the data burst in HS-PDSCH. The HS-SCCH also carries the HARQ process, redundancy version, and new data indicator information for the data burst. Additionally, the HS-SCCH carries the HS-SCCH cyclic sequence number which increments a UE specific cyclic sequence number for each HS-SCCH transmission. Further, the HS-SCCH carries the UE identity to indicate which UE should receive the data burst allocation.

The high-speed shared information channel (HS-SICH) is also referred to as the feedback channel. The HS-SICH carries the channel quality index (CQI), the recommended transport block size (RTBS) and the recommended modulation format (RMF). Additionally, the HS-SICH also carries the HARQ ACK/NACK of the HS-PDSCH transmissions.

In TD-HSDPA, the UE can be signaled by the UTRAN to monitor a subset of up to 4 HS-SCCHs (i.e., grant channels) to detect data allocation on the HS-SCCH, receive data on HS-PDSCH, and send HARQ acknowledgement (i.e., feedback) in the HS-SICH.

In TD-HSUPA, the following physical channels are relevant. The enhanced uplink dedicated channel (E-DCH) is a dedicated transport channel that features enhancements to an existing dedicated transport channel carrying data traffic.

The enhanced data channel (E-DCH) or enhanced physical uplink channel (E-PUCH) carries E-DCH traffic and schedule information (SI). Information in this E-PUCH channel can be transmitted in a burst fashion.

The E-DCH uplink control channel (E-UCCH) carries layer 1 (or physical layer) information for E-DCH transmissions. The transport block size may be 6 bits and the retransmission sequence number (RSN) may be 2 bits. Also, the hybrid automatic repeat request (HARQ) process ID may be 2 bits.

The E-DCH random access uplink control channel (E-RUCCH) is an uplink physical control channel that carries SI and enhanced radio network temporary identities (E-RNTI) for identifying UEs.

The absolute grant channel for E-DCH (enhanced access grant channel (E-AGCH)) carries grants for E-PUCH transmission, such as the maximum allowable E-PUCH transmission power, time slots, and code channels. The hybrid automatic repeat request (hybrid ARQ or HARQ) indication channel for E-DCH (E-HICH) carries HARQ ACK/NAK signals and is also known as the feedback channel.

The operation of TD-HSUPA may also have the following steps. First, in the resource request step, the UE sends requests (e.g., via scheduling information (SI)) via the E-PUCH or the E-RUCCH to a base station (e.g., NodeB). The requests are for permission to transmit on the uplink channels. Next, in a resource allocation step, the base station, which controls the uplink radio resources, allocates resources. Resources are allocated in terms of scheduling grants (SGs) to individual UEs based on their requests. In the third step (i.e., the UE Transmission step), the UE transmits on the uplink channels after receiving grants from the base station. The UE determines the transmission rate and the corresponding transport format combination (TFC) based on the received grants. The UE may also request additional grants if it has more data to transmit. Finally, in the fourth step (i.e., the base station reception step), a hybrid automatic repeat request (hybrid ARQ or HARQ) process is employed for the rapid retransmission of erroneously received data packets between the UE and the base station.

During the idle interval and/or dedicated channel measurement occasion (DMO), the UE does not transmit (TX) or receive (RX) communications. The length of the idle interval is referred to as M_Length and is configured to be less than the time to transmit interval (TTI) in the DMO. In one example, M_Length is 10 ms. When a high speed data channel (e.g., E-PUCH, HS-PDSCH) falls in a subframe within an idle interval or DMO, the NodeB does not send a grant channel and then the UE does not use the idle interval to decode the grant because it did not receive a grant. Aspects of the present disclosure are directed to utilizing the idle interval to extend a measurement gap for IRAT measurement(s).

Aspects of the present disclosure are directed to extending a measurement gap in high speed data networks. In particular, when a UE determines a high speed data channel will fall within a measurement gap, the UE does not monitor for a grant channel corresponding to the data channel. Instead, a measurement gap for IRAT measurement is extended to include the time slot containing the grant channel. The UE may then tune to other RATs and perform IRAT measurement(s) during the extended measurement gap. The UE determines the transmission will fall into the measurement gap based on the timing defined by the specifications.

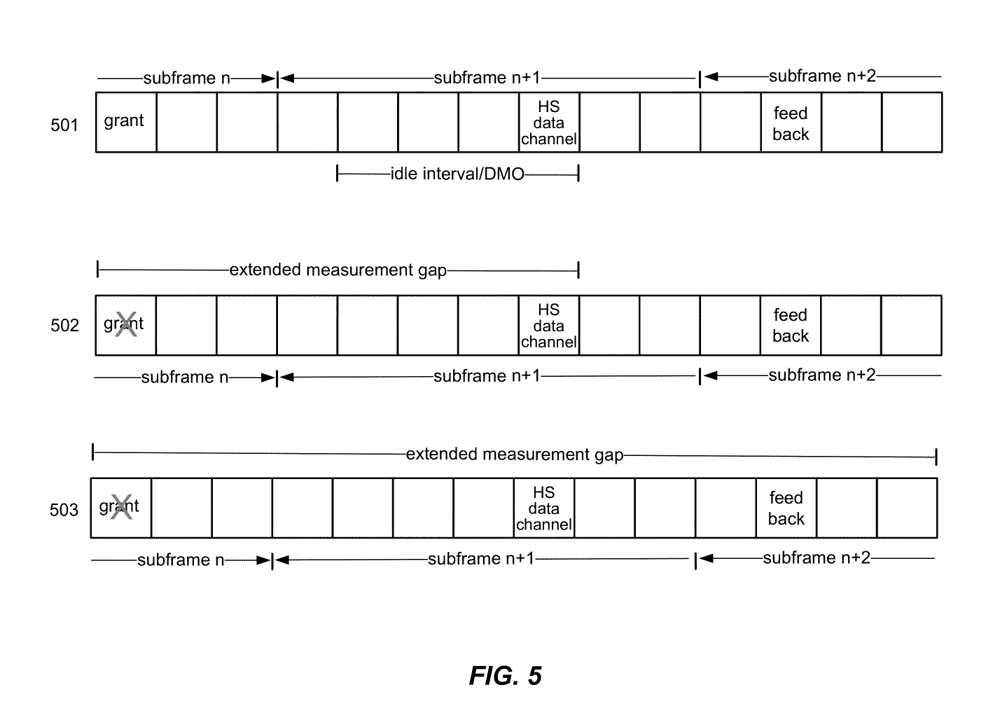

FIG. 5 illustrates example subframes in a telecommunications system. Each subframe includes time slots (TS0-TS6). The high speed data channel falls in subframe n+1, which is part of an idle interval or DMO, as seen in the timeline 501. Accordingly, the UE will not monitor for the grant that occurs in subframe n. Additionally, those skilled in the art will appreciate the high speed data channel can fall in time slots 3, 4, 5 or 6.

If the time slot(s) adjacent to where the high speed data channel falls in subframe n+1 is not allocated for other channels, a measurement gap is extended to use such time slot for performing IRAT measurement(s), as seen in the timeline 502.

Additionally, the UE may skip monitoring the feedback channel that occurs in subframe n+2. In one aspect, the measurement gap may be extended to include the time slot including the feedback channel in subframe n+2, as seen in the timeline 503.

Aspects of the present disclosure may be directed to high speed uplink data channels as well as high speed downlink data channels. For example, in TD-HSDPA, the timing of the grant channel (e.g., HS-SCCH) and corresponding high speed downlink data channel (i.e., HS-PDSCH) is defined by telecommunication specifications. If the high speed downlink data channel (i.e., HS-PDSCH) falls in the idle interval or DMO in sub-frame n+1, and if the time slot positioned adjacent the data channel is not allocated for other downlink channels by radio resource control (RRC) signaling, the UE will not monitor for the grant channel (HS-SCCH) in subframe n. The UE can utilize the time slot for tuning to other RATs and performing IRAT measurement(s). Additionally, when the HS-PDSCH falls in the idle interval, the time slot including the feedback channel (i.e., HS-SICH) may instead (or in addition to) be used to extend a measurement gap.

In TD-HSUPA, the timing between E-AGCH and E-PUCH is defined by telecommunication specifications. If the high speed uplink data channel (E-PUCH) falls into an idle interval or DMO in subframe n+1, and if the adjacent time slot is not allocated for other downlink channels by RRC signaling, then the UE will not monitor for the grant channel (E-AGCH) in subframe n. The UE can utilize the time slot for tuning to other RATs and performing IRAT measurement. Additionally, when E-AGCH falls in the idle interval, the time slot including the feedback channel (i.e., E-HICH) may instead be used to extend a measurement gap.

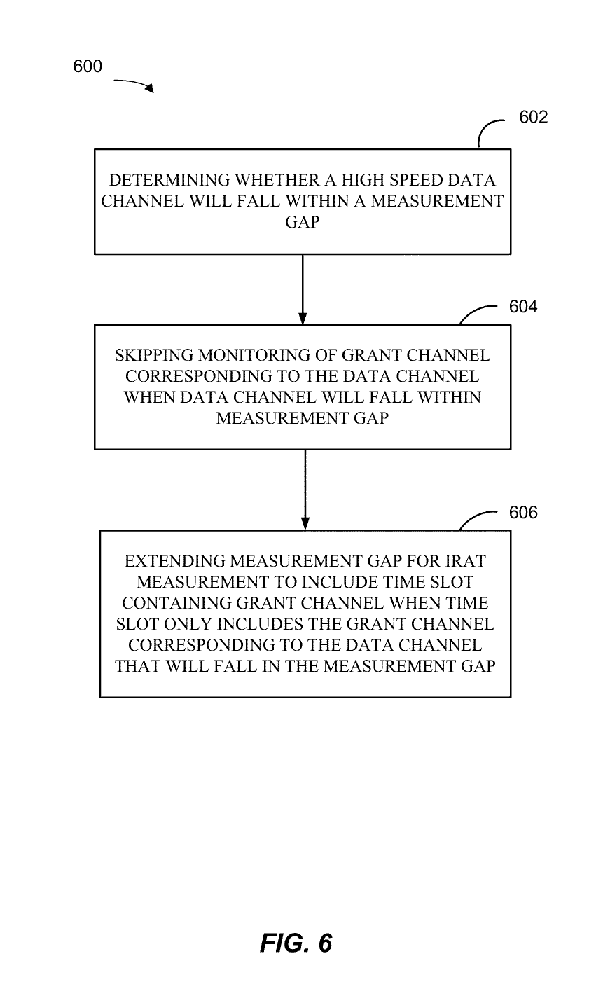

FIG. 6 shows a wireless communication method 602 according to one aspect of the disclosure. In block 602, a UE determines whether a high speed data channel will fall within a measurement gap. Next, in block 604, when the UE determines the data channel will fall into a measurement gap, the UE skips monitoring the grant channel corresponding to the data channel. The measurement gap is extended for IRAT measurement to include the time slot containing the grant channel when the time slot only includes the grant channel corresponding to the data channel that will fall in the measurement gap, as shown in block 606.

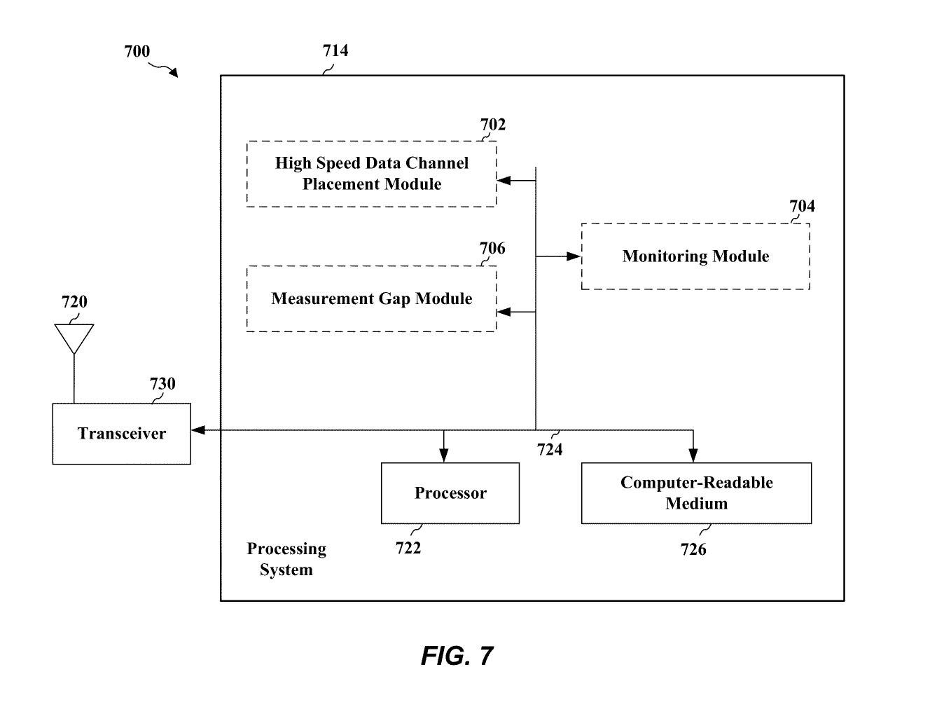

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, and 706, and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a high speed data channel placement module 702 for determining whether a high speed data channel will fall within a measurement gap. The processing system 714 includes a monitoring module 704 for skipping the monitoring of a grant channel. The processing system 714 includes a measurement gap module 706 for extending a measurement gap for IRAT measurement. The modules may be software modules running in the processor 622, resident/stored in the computer readable medium 626, one or more hardware modules coupled to the processor 622, or some combination thereof. The processing system 614 may be a component of the UE 350 and may include the memory 392, and/or the controller/processor 390.

In one configuration, an apparatus such as a UE is configured for wireless communication including means for determining. In one aspect, the determining means may be the controller/processor 390, the memory 392, gap management module 391, high speed data channel placement module 702, and/or the processing system 714 configured to perform the determining means. The UE is also configured to include means for skipping monitoring. In one aspect, the skipping monitoring means may be the antennas 352, the receiver 354, the channel processor 394, the receive frame processor 360, the receive processor 370, the controller/processor 390, the memory 392, gap management module 391, monitoring module 704 and/or the processing system 714 configured to perform the skipping monitoring means. The UE is also configured to include means for extending a measurement gap. In one aspect, the extending means may be the controller/processor 390, the memory 392, gap management module 391, measurement gap module 706 and/or the processing system 714 configured to perform the extending means. In another aspect, the aforementioned means may be a module or any apparatus configured to perform the functions recited by the aforementioned means.

Several aspects of a telecommunications system has been presented with reference to TD-SCDMA. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining whether a high speed data channel will fall within a measurement gap;
skipping monitoring of a grant channel corresponding to the high speed data channel, when the high speed data channel will fall within the measurement gap; and
extending the measurement gap for inter radio access technology (IRAT) measurement to include a time slot containing the grant channel when the time slot only includes the grant channel corresponding to the high speed data channel that will fall in the measurement gap.

2. The method of claim 1, further comprising:
performing the IRAT measurement during the extended measurement gap.

3. The method of claim 1, further comprising:
determining whether another channel falls within the time slot containing the grant channel; and
monitoring the grant channel when another channels falls within the time slot containing the grant channel.

4. The method of claim 1, further comprising:
skipping monitoring or transmitting of an acknowledgment feedback channel corresponding to the data channel, when the data channel will fall within the measurement gap; and
extending the measurement gap for inter radio access technology (IRAT) measurement to include a time slot containing the acknowledgment feedback channel when the time slot only includes the acknowledgment feedback channel.

5. The method of claim 4, in which the acknowledgement feedback channel is a High-Speed Shared Information Channel (HS-SICH).

6. The method of claim 4, in which the acknowledgement feedback channel is Hybrid ARQ Indication Channel for E-DCH (E-HICH).

7. The method of claim 4, further comprising:
determining whether another channel falls within the time slot for the acknowledgment feedback channel; and
monitoring or transmitting the acknowledgment feedback channel when another channels falls within the time slot containing the acknowledgment feedback channel.

8. The method of claim 1, further comprising:
determining whether any downlink or uplink channels fall within at least one time slot adjacent to the time slot containing the grant channel; and
extending the measurement gap for inter radio access technology (IRAT) measurement to include the at least one adjacent time slot when no downlink or uplink channel falls within the at least one adjacent time slot.

9. The method of claim 1, further comprising:
determining whether any downlink or uplink channels fall within at least one time slot adjacent to the time slot containing an acknowledgment feedback channel; and
extending the measurement gap for inter radio access technology (IRAT) measurement to include the at least one adjacent time slot when no downlink or uplink channel falls within the at least one adjacent time slot.

10. The method of claim 1, in which the high speed data channel is a downlink (DL) high speed data channel.

11. The method of claim 10, in which the grant channel is a High-Speed Shared Control Channel (HS-SCCH).

12. The method of claim 1, in which the high speed data channel is an uplink (UL) high speed data channel.

13. The method of claim 12, in which the grant channel is an Absolute Grant Channel (E-AGCH) for E-DCH.

14. An apparatus for wireless communication, comprising:
a memory; and
at least one processor coupled to the memory, the at least one processor being configured:
to determine whether a high speed data channel will fall within a measurement gap;
to skip monitoring of a grant channel corresponding to the high speed data channel, when the high speed data channel will fall within the measurement gap; and
to extend the measurement gap for inter radio access technology (IRAT) measurement to include a time slot containing the grant channel when the time slot only includes the grant channel corresponding to the high speed data channel that will fall in the measurement gap.

15. The apparatus of claim 14, in which the at least one processor is further configured to perform the IRAT measurement during the extended measurement gap.

16. The apparatus of claim 14, in which the at least one processor is further configured:
to determine whether another channel falls within the time slot containing the grant channel; and
to monitor the grant channel when another channels falls within the time slot containing the grant channel.

17. The apparatus of claim 14, in which the at least one processor is further configured: to skip monitoring or transmitting of an acknowledgment feedback channel corresponding to the data channel, when the data channel will fall within the measurement gap; and
to extend the measurement gap for inter radio access technology (IRAT) measurement to include a time slot containing the acknowledgment feedback channel when the time slot only includes the acknowledgment feedback channel.

18. The apparatus of claim 17, in which the acknowledgement feedback channel is a High-Speed Shared Information Channel (HS-SICH).

19. The apparatus of claim 17, in which the acknowledgement feedback channel is Hybrid ARQ Indication Channel for E-DCH (E-HICH).

20. The apparatus of claim 17, in which the at least one processor is further configured: to determine whether another channel falls within the time slot for the acknowledgment feedback channel; and
to monitor or transmit the acknowledgment feedback channel when another channels falls within the time slot containing the acknowledgment feedback channel.

21. The apparatus of claim 14, in which the at least one processor is further configured:
to determine whether any downlink or uplink channels fall within at least one time slot adjacent to the time slot containing the grant channel; and
to extend the measurement gap for inter radio access technology (IRAT) measurement to include the at least one adjacent time slot when no downlink or uplink channel falls within the at least one adjacent time slot.

22. The apparatus of claim 14, in which the at least one processor is further configured:
to determine whether any downlink or uplink channels fall within at least one time slot adjacent to the time slot containing an acknowledgment feedback channel; and
to extend the measurement gap for inter radio access technology (IRAT) measurement to include the at least one adjacent time slot when no downlink or uplink channel falls within the at least one adjacent time slot.

23. The apparatus of claim 14, in which the high speed data channel is a downlink (DL) high speed data channel.

24. The apparatus of claim 23, in which the grant channel is a High-Speed Shared Control Channel (HS-SCCH).

25. The apparatus of claim 14, in which the high speed data channel is an uplink (UL) high speed data channel.

26. The apparatus of claim 25, in which the grant channel is an Absolute Grant Channel (E-AGCH) for E-DCH.

27. A computer program product for wireless communication in a wireless network, comprising:
a non-transitory computer-readable medium having non-transitory program code recorded thereon, the program code comprising:
program code to determine whether a high speed data channel will fall within a measurement gap;
program code to skip monitoring of a grant channel corresponding to the high speed data channel, when the high speed data channel will fall within the measurement gap; and
program code to extend the measurement gap for inter radio access technology (IRAT) measurement to include a time slot containing the grant channel when the time slot only includes the grant channel corresponding to the high speed data channel that will fall in the measurement gap.

28. An apparatus for wireless communication, comprising:
means for determining whether a high speed data channel will fall within a measurement gap;
means for skipping monitoring of a grant channel corresponding to the high speed data channel, when the high speed data channel will fall within the measurement gap; and
means for extending the measurement gap for inter radio access technology (IRAT) measurement to include a time slot containing the grant channel when the time slot only includes the grant channel corresponding to the high speed data channel that will fall in the measurement gap.
